(19) United States
(12) Patent Application Publication
(10) Pub. No.: US 2024/0159301 A1
(43) Pub. Date: May 16, 2024

(54) TORQUE CONVERTER ASSEMBLY

(71) Applicant: Schaeffler Technologies AG & Co. KG, Herzogenaurach (DE)

(72) Inventors: Juan Pablo Cazares, Puebla (MX); David Baez, Puebla (MX)

(73) Assignee: Schaeffler Technologies AG & Co. KG, Herzogenaurach (DE)

(21) Appl. No.: 17/984,370

(22) Filed: Nov. 10, 2022

(51) Int. Cl. F16H 41/28

(52) U.S. Cl. CPC F16H 41/28; F16H 2041/243

(57) ABSTRACT

A torque converter assembly and a method of assembling torque converter components is disclosed herein. The torque converter can include a turbine and a secondary component configured to be connected to the turbine. The connection interface between the turbine and the secondary component can be provided solely via deformation of a portion of the turbine, such as an integrally formed flange, such that the turbine and the secondary component are connected with each other.

### FIELD OF INVENTION

The present disclosure generally relates to a torque converter assembly, and more specifically relates to a fastening or connection interface for components of the torque converter assembly.

### BACKGROUND

Torque converter assemblies are generally known. Torque converter assemblies can be provided in various configurations, but generally include a turbine that is configured to support a plurality of blades, and at least one adjacent or adjoining component, herein referred to as a secondary component.

The secondary component can vary depending on the specifics of the torque converter assembly, and the secondary component could include a hub component, plate, or flange, for example. Connections between the secondary component and the turbine are typically provided via use of separately formed rivets 1 (i.e. extruded rivets), which include enlarged ends on opposing ends as generally shown in FIGS. 1A and 1B. These known rivets are undesirable due to increased clearance/installation space that they require, as well as adding complexity to the assembly process and increasing the weight of the assembly.

Accordingly, it would be desirable to provide an improved connection interface for a turbine with a secondary component in a torque converter assembly.

### SUMMARY

As disclosed herein, a turbine assembly generally including a turbine and a secondary component is provided. The turbine can include a body defining a plurality of openings for blades and a plurality of fastening elements. The secondary component includes a plurality of openings configured to receive a respective one of the plurality of fastening elements. The turbine can be configured to be fixed relative to the secondary component via insertion of the plurality of fastening elements through the plurality of openings and deformation of the plurality of fastening elements. Based on this configuration, a connection between the turbine and the secondary component is provided without the need for a separately formed rivet or other fastening component. This provides advantages due to a reduction in weight and a reduction in the installation space/envelope of the components. This configuration also provides improvements with torque loading. The configurations disclosed herein provides an improved torsional loading structure.

The fastening elements can each be formed as an axially extending tab in a pre-installed state. The plurality of fastening elements can be defined along a radially inner edge of the body. The plurality of fastening elements can be defined in a medial area defined between a radially inner edge and a radially outer edge of the body in another example. The turbine can be formed from stamped sheet metal, and the plurality of fastening elements can be formed integrally with the body of the turbine.

The plurality of fastening elements can be configured to extend in a first axial direction away from the body such that a surface of the body of the turbine facing a second axial direction that is opposite from the first axial direction has a flat profile.

The secondary component can be any number of components, such as a hub, a cover plate, or a drive ring. Each of these components can include a plurality of openings configured to be aligned with and receive a respective one of the plurality of fastening elements.

Any one or more of the secondary components can further include a recess arranged around each of the plurality of openings, such that deformation of the plurality of fastening elements causes a deformed portion of the plurality of fastening elements to be entirely housed within the recess. The fastening elements can flatten out or take on a mushroom-like deformed shape.

The turbine can further include a plurality of abutment surfaces interspersed between the plurality of fastening elements, and the plurality of abutment surfaces can be configured to directly contact a face of the secondary component. The provides a more stable connection between the turbine and the secondary component.

A method of assembling torque converter components is also disclosed herein. The method can include providing a turbine including a body defining a plurality of fastening elements integrally formed with the body; and a secondary component including a plurality of openings configured to receive a respective one of the plurality of fastening elements. The method can include inserting the plurality of fastening elements within the plurality of openings. The method can also include deforming the plurality of fastening elements such that the turbine and the secondary component are connected with each other. The method can further include applying an induction hardening treatment at least to an area of the turbine including the plurality of fastening elements.

Additional embodiments are disclosed herein.

### BRIEF DESCRIPTION OF THE DRAWINGS

The foregoing Summary and the following Detailed Description will be better understood when read in conjunction with the appended drawings, which illustrate a preferred embodiment of the disclosure. In the drawings:

FIG. 1A is a cross-sectional perspective view of a torque converter according to the prior art.

FIG. 1B is another cross-sectional perspective view of a torque converter according to the prior art.

FIG. 2A is a perspective view of a turbine according to one example of the present disclosure.

FIG. 2B is a magnified view of a radially inner edge of the turbine of FIG. 2A.

FIG. 2C is a perspective view of a hub configured to be connected to the turbine of FIGS. 2A and 2B.

FIG. 3A is a perspective view showing a cross-section of a turbine assembly including the turbine and the hub of FIGS. 2A-2C.

FIG. 3B is another perspective view showing a cross-section of a turbine assembly of FIG. 3A.

FIG. 3C is a magnified cross-sectional view of a first area of the turbine assembly of FIG. 3A.

FIG. 3D is a magnified cross-sectional view of a second area of the turbine assembly of FIG. 3A.

FIG. 3E is a magnified perspective view of a cross-section of the turbine assembly of FIG. 3A.

FIG. 3F is a perspective view of a first side of the turbine assembly of FIG. 3A.

FIG. 3G is a perspective view of a second side of the turbine assembly of FIG. 3A.

FIG. 311 is a magnified perspective view of another aspect of the turbine assembly of FIG. 3A.

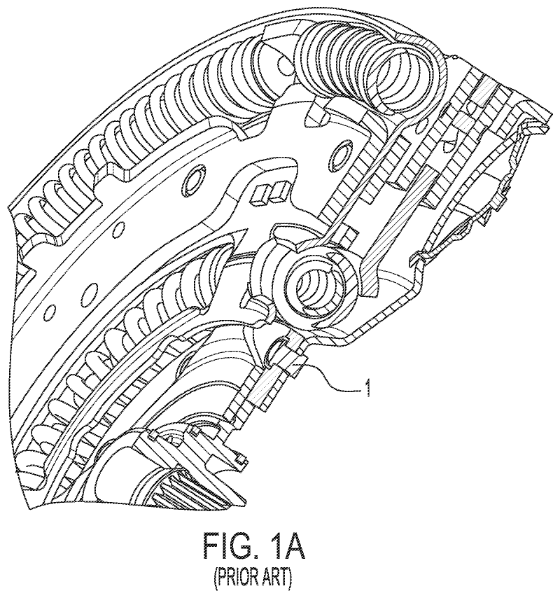

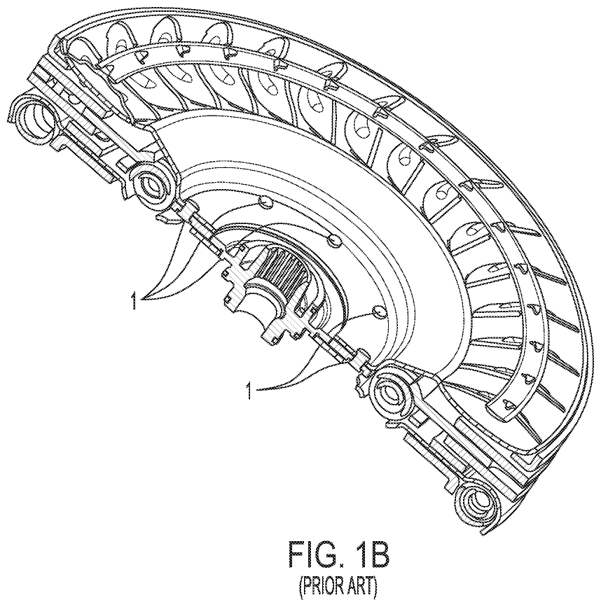

FIG. 4A is a perspective view of a turbine according to one example of the present disclosure.

FIG. 4B is a magnified view of a medial area of the turbine of FIG. 4A.

FIG. 4C is a partial front view of a drive ring configured to be connected to the turbine of FIGS. 4A and 4B.

FIG. 5A is a perspective view showing a cross-section of a turbine assembly including the turbine and the drive ring of FIGS. 4A-4C.

FIG. 5B is a top view of the turbine assembly of FIG. 5A.

FIG. 5C is a perspective view of the turbine assembly of FIG. 5A.

FIG. 6A is a perspective view of a first side of a turbine according to one example of the present disclosure.

FIG. 6B is a perspective view of a second side of the turbine of FIG. 6A.

FIG. 6C is a magnified perspective view of a radially inner edge of the turbine of FIG. 6A.

FIG. 7A is a perspective view of a first side a cover plate according to one example of the present disclosure.

FIG. 7B is a perspective view of a second side of the cover plate of FIG. 7A.

FIG. 7C is a magnified perspective view of a radially inner edge of the cover plate of FIG. 7A.

FIG. 8A is a partial perspective view of a cross-section of a turbine assembly including the turbine of FIGS. 6A-6C and the cover plate of FIGS. 7A-7C in a partially installed state.

FIG. 8B is a magnified view of a cross-section of a first area of the turbine assembly of FIG. 8A.

FIG. 8C is a magnified view of a cross-section of a second area of the turbine assembly of FIG. 8A.

FIG. 8D is a magnified view of cross-section of a portion of the turbine assembly of FIG. 8A.

FIG. 9A is a partial perspective view of a cross-section of the turbine assembly of FIGS. 8A-8D in a fully installed state.

FIG. 9B is a magnified view of a cross-section of a first area of the turbine assembly of FIG. 9A.

FIG. 9C is a magnified view of a cross-section of a second area of the turbine assembly of FIG. 9A.

FIG. 9D is a magnified view of cross-section of a portion of the turbine assembly of FIG. 9A.

FIG. 10A is a magnified cross-sectional view of a fastening element of the turbine extending through an opening in the cover plate in a partially installed state.

FIG. 10B is a perspective, magnified view of a cross-section of the interface shown in FIG. 10A.

FIG. 10C is a top view of a cross-section of the interface shown in FIGS. 10A and 10B.

FIG. 11A is a magnified cross-sectional view of a fastening element of the turbine extending through an opening in the cover plate in a fully installed state.

FIG. 11B is a perspective, magnified view of a cross-section of the interface shown in FIG. 11A.

FIG. 11C is a top view of a cross-section of the interface shown in FIGS. 11A and 11B.

FIG. 12A is a front view of a turbine assembly according to one example of the present disclosure in a partially installed state.

FIG. 12B is a rear view of the turbine assembly of FIG. 12A.

FIG. 13A is a front view of the turbine assembly of FIG. 12A in a fully installed state.

FIG. 13B is a rear view of the turbine assembly of FIG. 13A.

FIG. 14A is a perspective view of a first side of a turbine according to one example of the present disclosure.

FIG. 14B is a perspective view of a second side of the turbine of FIG. 14A.

FIG. 14C is a front view of the turbine of FIGS. 14A and 14B.

FIG. 14D is a rear view of the turbine of FIGS. 14A-14C.

### DETAILED DESCRIPTION OF THE PREFERRED EMBODIMENTS

Certain terminology is used in the following description for convenience only and is not limiting. “Axially” refers to a direction along an axis (X) of an assembly. “Radially” refers to a direction inward and outward from the axis (X) of the assembly.

A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

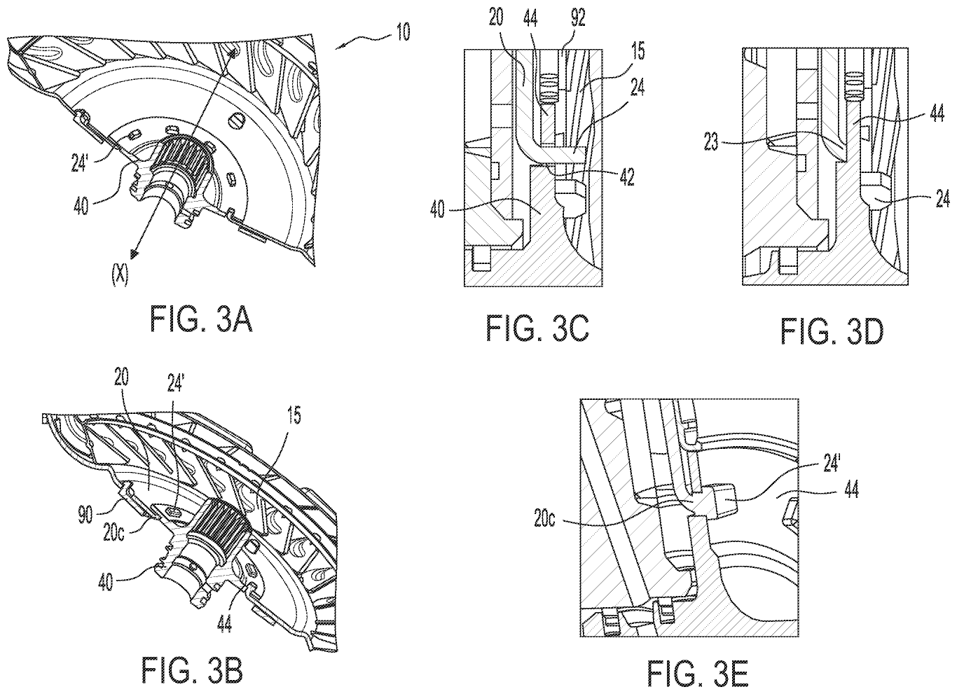

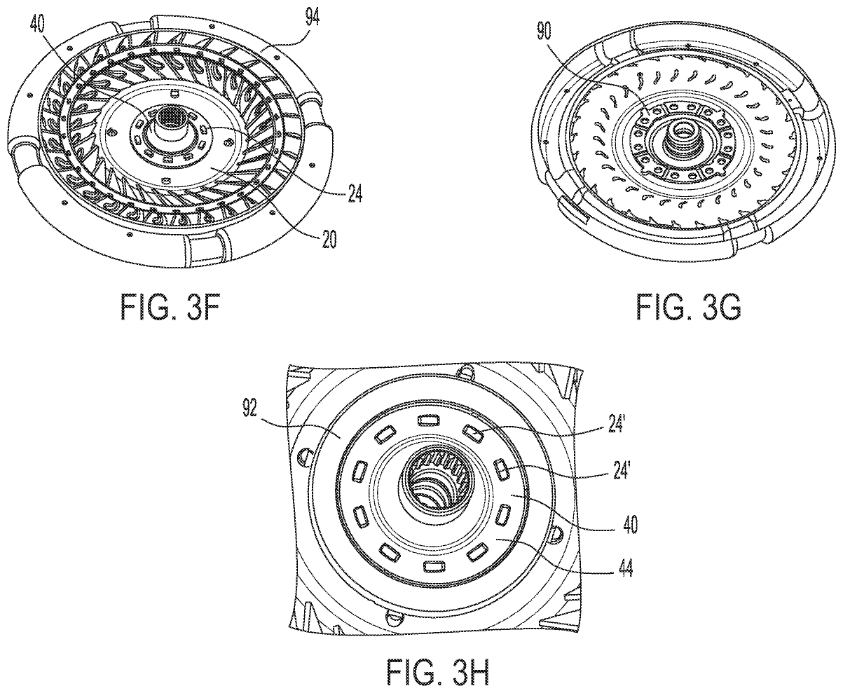

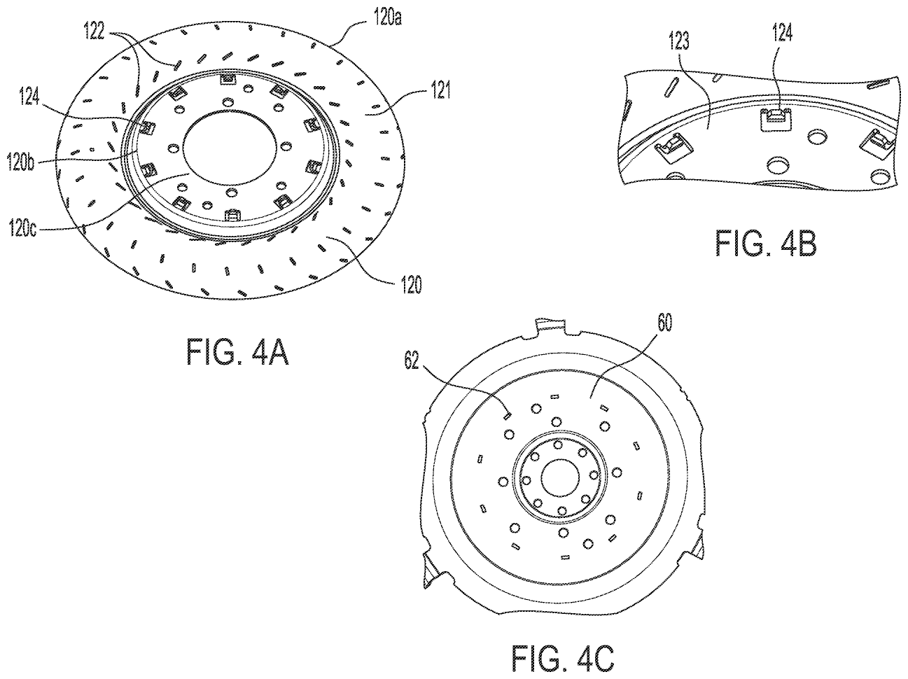

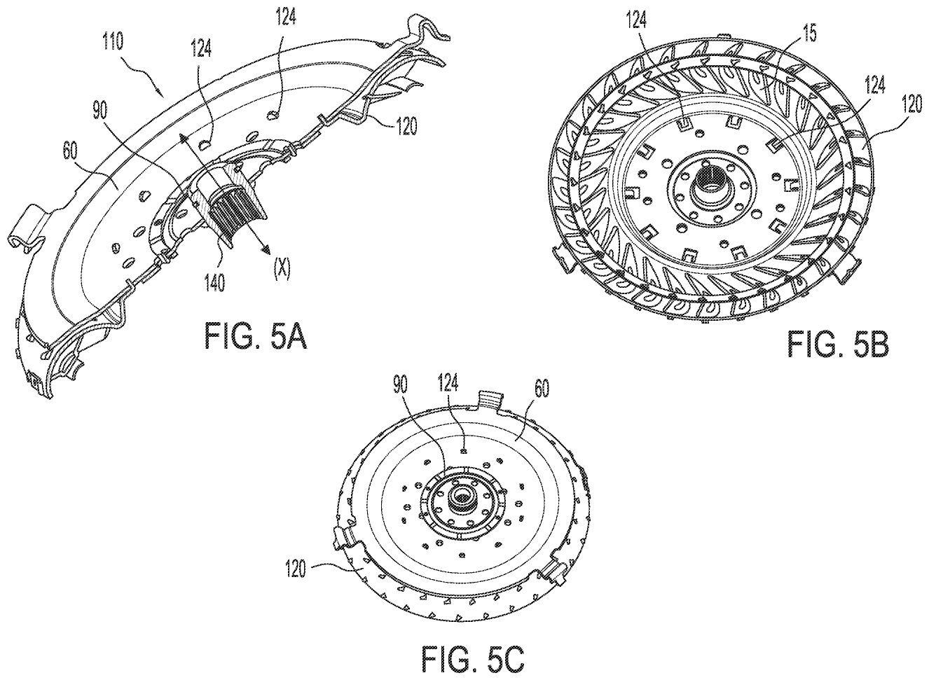

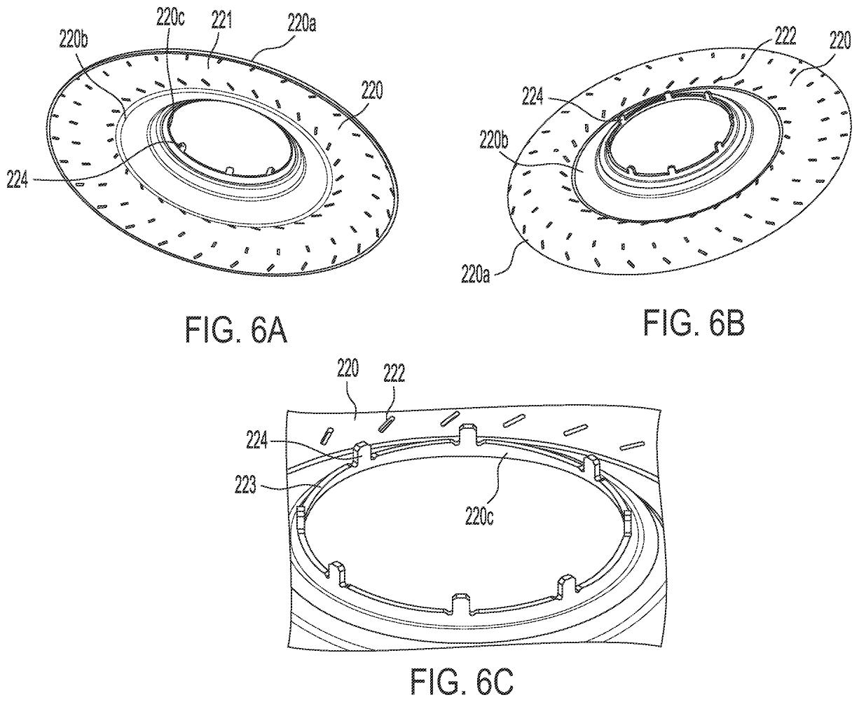

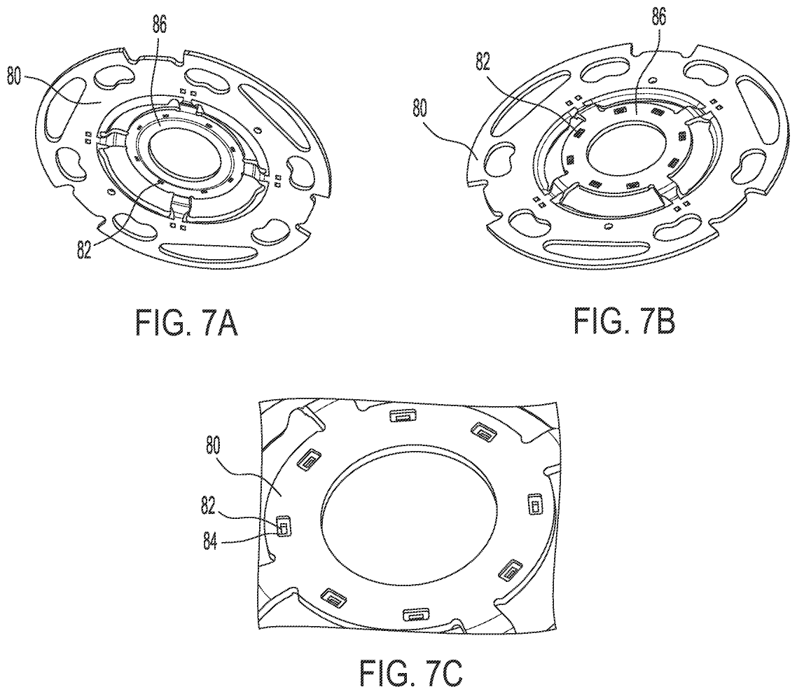

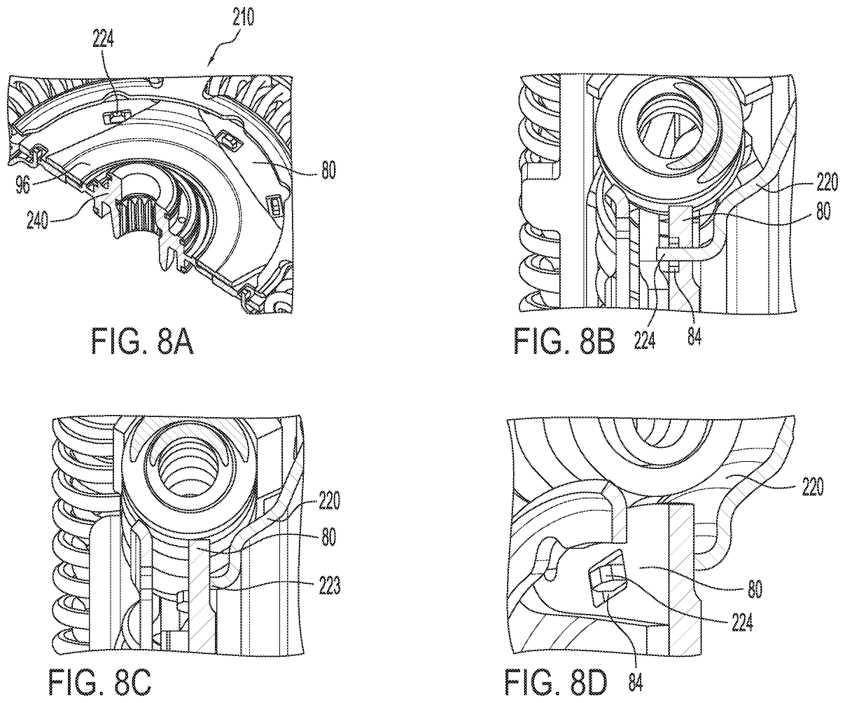

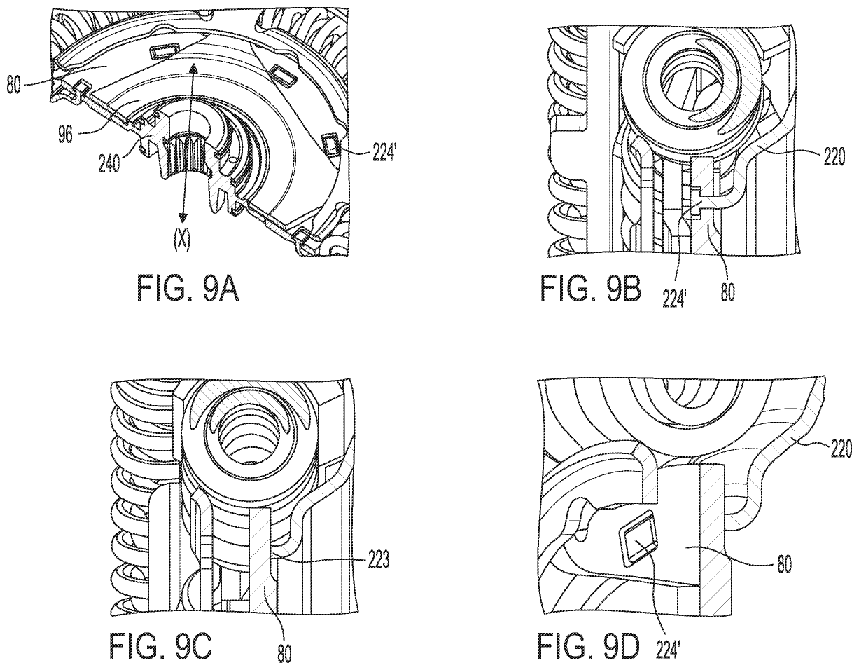

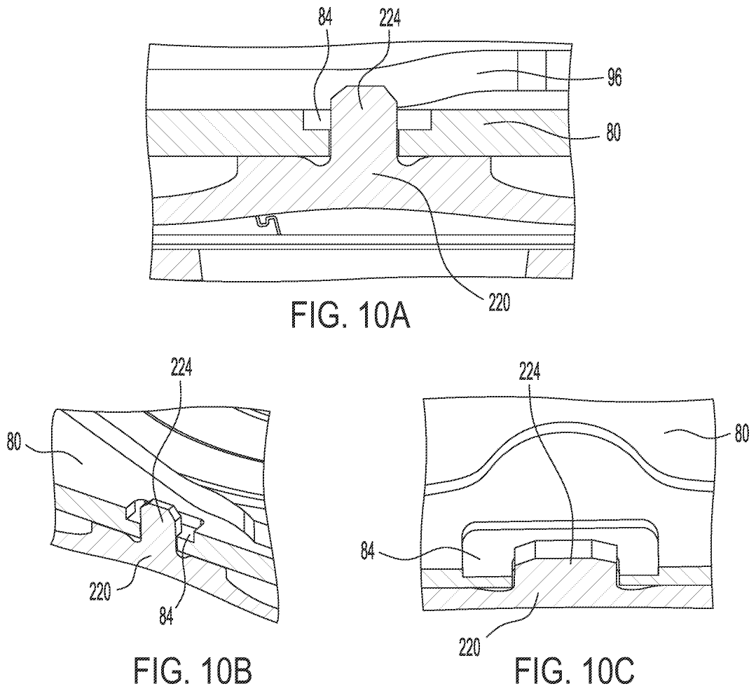

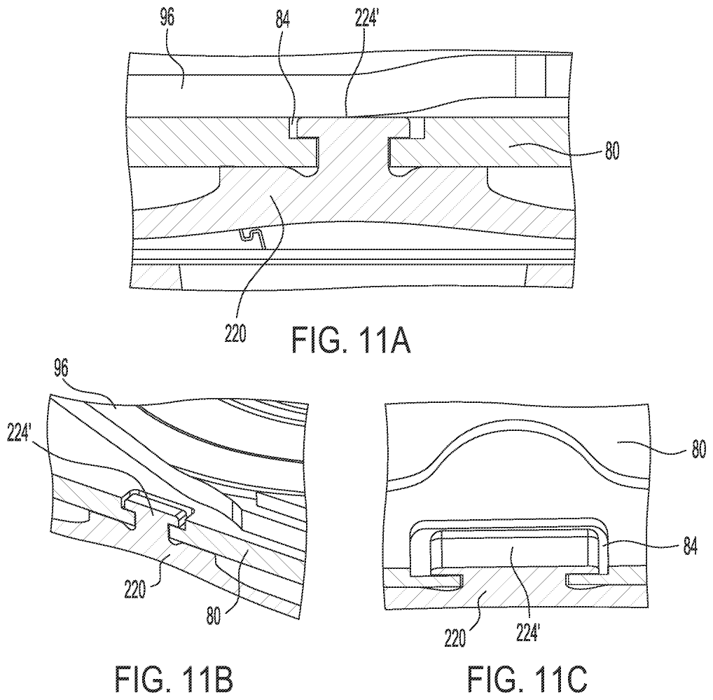

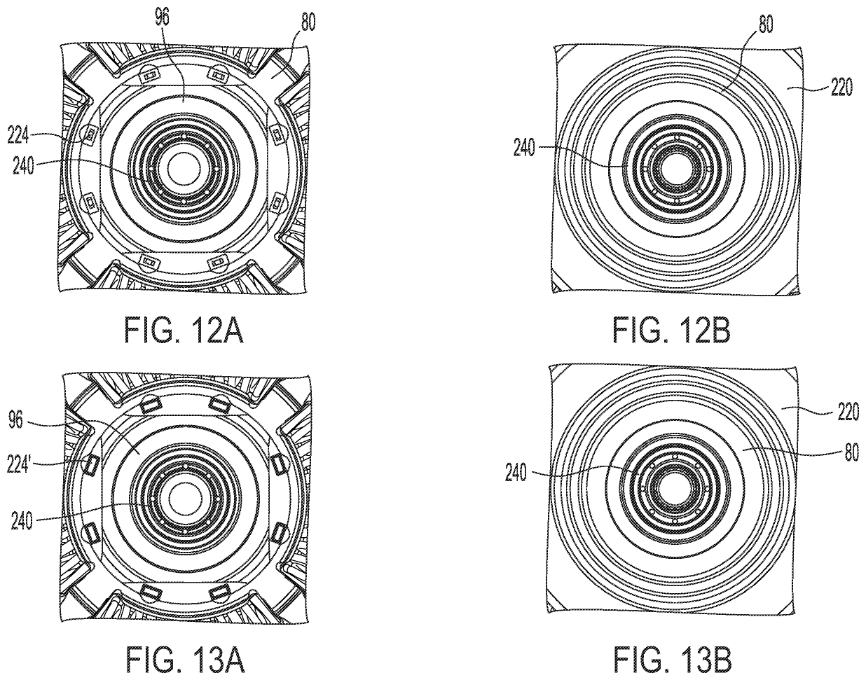

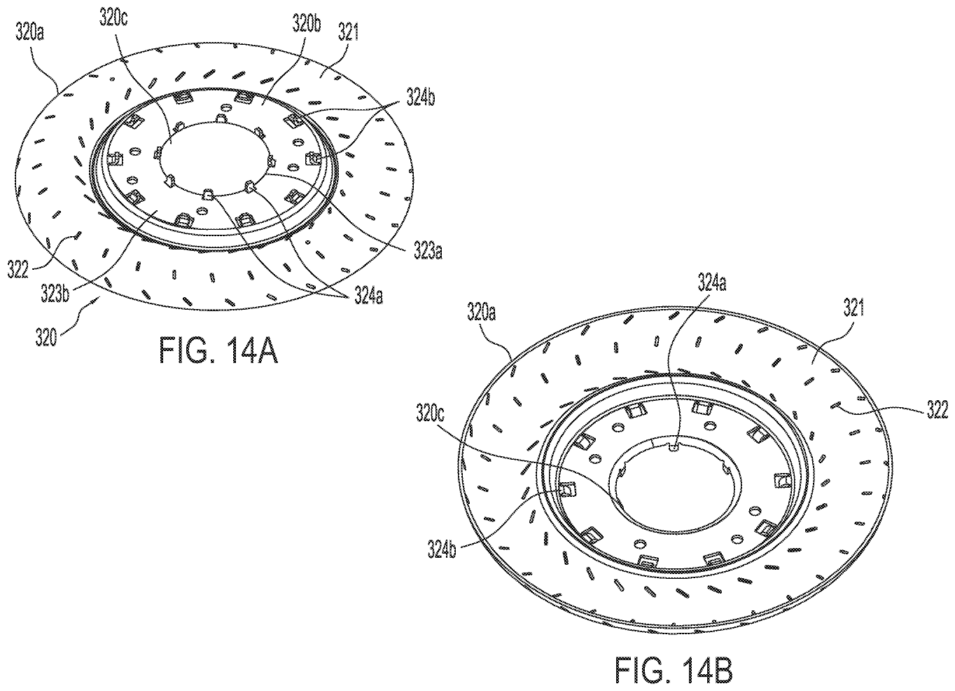

A turbine assembly is generally disclosed herein that can include various sub-components and structural aspects. Exemplary turbine assemblies 10, 110, 210 are shown in various assembled states, such as in FIGS. 3A-3H, 5A-5C, 8A-8D, 9A-9D, 10A-10C, 11A-11C, 12A, 12B, 13A, and 13B. These turbine assemblies and the various sub-components are described in more detail herein.

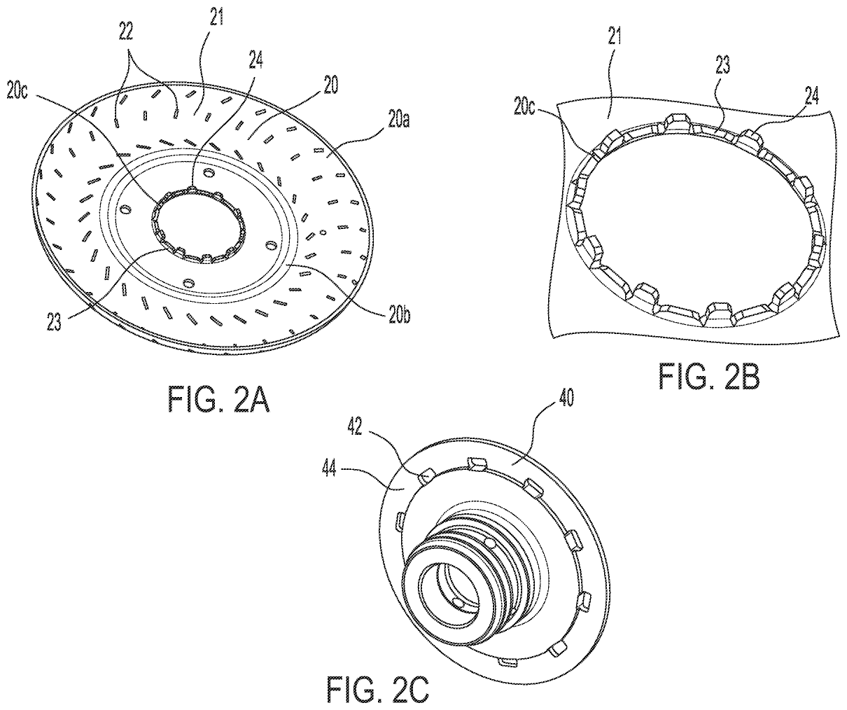

As shown in FIGS. 2A, 2B, and 3A-3H, in one example, the turbine assembly can include a turbine 20 including a body 21 defining a plurality of openings 22 configured to receive a portion of a blade 15. The blades 15 can be attached or connected to the turbine 20 according to various interfaces, as well known by those of ordinary skill in the art. Various examples and embodiments of the turbine are disclosed herein and are designated by reference numerals 20, 120, 220, 320. The general configuration (i.e. radially outer edges 20a, 120a, 220a, 320a; radially inner edges 20c, 120c, 220c, 320c; medial area 20b, 120b, 220b, 320b; body 21, 121, 221, 321; openings 22, 122, 222, 322 for blades; abutment surface 23, 123, 223, 323a, 323b; fastening elements 24, 124, 224, 324a, 324b) of each of the turbines is similar unless specifically identified herein.

The turbine 20 further includes a plurality of fastening elements 24. The fastening elements 24 are integrally formed with the body 21 of the turbine 20, in one example. The fastening elements 24 can be considered rolling rivets. The fastening elements 24 can be formed as axially extending tabs in an initial or partially installed state. The turbine 20 can be formed from sheet metal, such as stamped sheet metal, and the fastening elements 24 can be integrally formed with the turbine 20 via a punching or stamping operation or step. One of ordinary skill in the art would understand that various methods and steps could be used to form the turbine 20 and its sub-elements. The turbine 20 can include a radially outer edge 20a, a radially inner edge 20c, and a medial area 20b defined therebetween.

A secondary component, which can be any number of various components described herein, can generally be configured to be attached or connected to the turbine 20 via use of the fastening elements 24 formed on the turbine. The secondary component can include a plurality of openings that are each configured to receive a respective one of the plurality of fastening elements 24. The turbine 20 is configured to be fixed relative to the secondary component via insertion of the plurality of fastening elements 24 through the plurality of openings and subsequent deformation of the plurality of fastening elements 24. This arrangement ensures that the turbine and the secondary component are rotationally locked with each other.

Further description of specific examples are provided herein, in which the secondary component can be at least one of a hub 40 (as shown in FIGS. 2C and 3A-311), a drive ring 60 (as shown in FIGS. 4C and 5A-5C), or a cover plate 80 (as shown in FIGS. 7A-13B). One of ordinary skill in the art would understand based on this disclosure that the concepts and connection interface of the turbine 20 can be adapted to other components of the torque converter assembly.

Referring specifically to FIGS. 2A and 2B, the plurality of fastening elements 24 can be defined along a radially inner edge 20c of the body 21. The plurality of fastening elements 224 of turbine 220 are also defined along a radially inner edge 220c of the body 221, as shown in FIGS. 6A-6C.

Referring to FIGS. 2C and 3A-311, the secondary component can be the hub 40, and the hub 40 can include a plurality of hub openings 42 that are each aligned with a respective one of the plurality of fastening elements 24. The hub 40 can include a flange 44 that extends radially outward and defines the plurality of hub openings 42. As shown in FIGS. 3C and 3D, in certain regions, the plurality of fastening elements 24 extend through the plurality of hub openings 42, and in other areas circumferentially offset from the plurality of hub openings 42, an abutment surface 23 of the turbine 20 contacts or abuts against the flange 44.

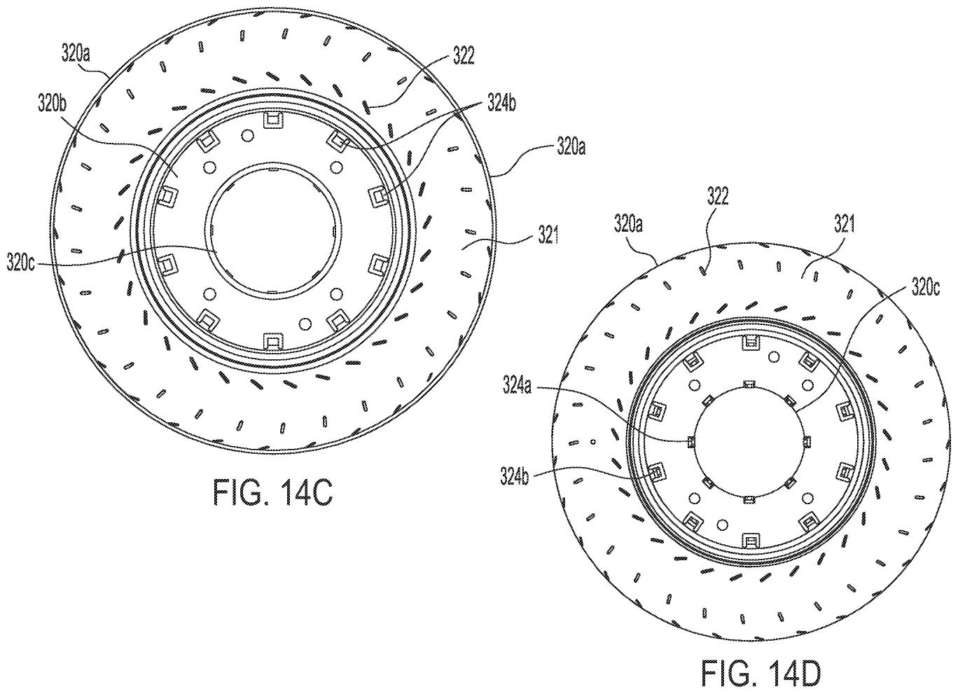

As shown, for example, in FIGS. 3A, 3B, 3E, and 311, the fastening elements 24′ are deformed such that the turbine 20 and the hub 40 are fastened together. Deformation of the fastening elements 24′ can be achieved via application of a force, such as via a deformation tool, press, or other instrument. For example, in one configuration, a supporting tool can be provided on one side of the assembly, and a punching tool is provided on the other side of the assembly. One of ordinary skill in the art would understand that various punching or pressing machines can be used.

Referring to FIGS. 4C and 5A-5C, the secondary component can be the drive ring 60, and the drive ring 60 can include a plurality of drive ring openings 62 each aligned with a respective one of the plurality of fastening elements 24.

Referring specifically to FIGS. 4A and 4B, the plurality of fastening elements 124 can be defined in a medial area 120b defined between a radially inner edge 120c and a radially outer edge 120a of the body 121. The plurality of fastening elements 24 can be configured to extend in a first axial direction away from the body 21 such that a surface of the body 21 of the turbine facing a second axial direction that is opposite from the first axial direction has a flat profile. This provides advantages with respect to conserving space for the torque converter, that would otherwise need to be occupied by a rivet head or other aspect of known fastening components. As shown in FIGS. 4A and 4B, an abutment surface 123 of the turbine 120 can be defined that is configured to contact or abut against the drive ring 60, which is shown in FIG. 4C.

As shown in FIGS. 6A-6C, the turbine 220 includes a plurality of fastening element 224 along a radially inner edge 220c of a body 221 of the turbine 220. Abutment surfaces 223 can be arranged between the fastening elements 224.

Referring to FIGS. 7A-13B, the secondary component can be a cover plate 80, and the cover plate 80 can include a plurality of cover plate openings 82 each aligned with a respective one of the plurality of fastening elements 224. As shown in more detail in FIGS. 7C, 8B, 8D, 9B, 9D, and 10A-11C, for example, each of the plurality of cover plate openings 82 can include a recess 84 (i.e. a counter sunk structure), such that deformation of the plurality of fastening elements 224 causes a deformed portion of the plurality of fastening elements 224 to be entirely housed within the recess 84.

In one example, a further treatment, such as a hardening treatment can be applied to the fastening elements 24, 124, 224, 324a, 324b, as well as areas adjacent to the fastening elements 24, 124, 224, 324a, 324b such as the abutment surfaces 23, 123, 223, 323a, 323b. The hardening treatment can be an induction hardening treatment, in one example.

One of ordinary skill in the art would understand that in another embodiment, the secondary component could include tabs or fastening elements and the turbine could include openings configured to receive the tabs or fastening elements. For example, as shown in FIGS. 14A-14D, a turbine 320 can comprise a first set of fastening elements 324a and a second set of fastening elements 324b. The turbine 320 can also include a body 321 defining a radially inner edge 320c, a radially outer edge 320a, and a medial region 320b. The turbine 320 can also include a plurality of openings 322 for blades as well. The first set of fastening elements 324a and the second set of fastening elements 324b can be spaced apart from each other in a radial direction. The first set of fastening elements 324a can be defined along the radially inner edge 320c of the body 321, and the second set of fastening elements 324b can be defined in a medial region 320b of the body 321. Abutment surfaces 323a can be arranged circumferentially between the first set of fastening elements 324a, and abutment surfaces 323b can be arranged circumferentially between the second set of fastening elements 324b.

One of ordinary skill in the art would understand that additional modifications to the turbine can be provided. For example, in one configuration, the turbine can include a first set of fastening elements (i.e. fastening elements 24, 124, 224), and a second set of fastening elements, such as a secondary row of tabs circumferentially spread apart from each other. The first set of fastening elements can be provided for a driving mode, and the second set of fastening elements can be provided for a coasting mode. The second set of fastening elements can extend in an axial direction that is opposite from the axial direction of the first set of fastening elements. This configuration can be advantageous due to improvements with loading during a coasting mode.

A method of assembling torque converter components is also disclosed herein. The method can include providing: a turbine including a body defining a plurality of fastening elements integrally formed with the body; and a secondary component including a plurality of openings configured to receive a respective one of the plurality of fastening elements. The method can include inserting the plurality of fastening elements within the plurality of openings and then deforming the plurality of fastening elements such that the turbine and the secondary component are connected with each other.

Various other components of the torque converter are illustrated throughout the Figures. For example, as shown in FIGS. 3B-311, the torque converter can include a thrust washer 90 in abutment with a first side of the turbine 20, a bearing 92 in abutment with a second side of the turbine 20, and a spring retainer 94. As shown in FIGS. 8A-9D, 10A, 10B, 11A, 11B, 12A, and 13A, a hub plate 96 can be provided that is attached to the hub 240. One of ordinary skill in the art would understand based on this disclosure that additional features not specifically mentioned herein can be included.

One of ordinary skill in the art would understand that the quantity of the fastening elements and the quantity of the openings on the secondary component can be selected to be identical. The exact number of fastening elements and openings can vary depending on the requirements of a particular application.

Having thus described the present disclosure in detail, it is to be appreciated and will be apparent to those skilled in the art that many physical changes, only a few of which are exemplified in the detailed description of the invention, could be made without altering the inventive concepts and principles embodied therein.

It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the embodiments being indicated by the appended claims rather than by the foregoing description, and all alternate embodiments and changes to this embodiment which come within the meaning and range of equivalency of said claims are therefore to be embraced therein.

### LOG OF REFERENCE NUMERALS

Rivet 1
Turbine Assembly 10, 110, 210
Blades 15
Turbine 20, 120, 220, 320
Body 21, 121, 221, 321
Radially outer edge 20a, 120a, 220a, 320a of turbine
Radially medial area 20b, 120b, 220b, 320b of turbine
Radially inner edge 20c, 120c, 220c, 320c of turbine
Openings 22, 122, 222, 322
Abutment Support 23, 123, 223, 323a, 323b
Fastening Elements 24, 124, 224, 324a, 324b
Hub 40, 140, 240
Hub Openings 42
Hub Flange 44
Drive Ring 60
Drive Ring Openings 62
Cover Plate 80
Cover Plate Openings 82
Recess 84
Inner Ring Body 86
Thrust Washer 90
Bearing 92
Spring Retainer 94
Hub Plate 96

What is claimed is:

1. A turbine assembly comprising:
a turbine including a body defining a plurality of openings for blades and a plurality of fastening elements; and
a secondary component including a plurality of openings configured to receive a respective one of the plurality of fastening elements;
wherein the turbine is configured to be fixed relative to the secondary component via insertion of the plurality of fastening elements through the plurality of openings and deformation of the plurality of fastening elements.

2. The turbine assembly according to claim 1, wherein the fastening elements are formed as an axially extending tab in a pre-installed state.

3. The turbine assembly according to claim 1, wherein the plurality of fastening elements are defined along a radially inner edge of the body.

4. The turbine assembly according to claim 1, wherein the plurality of fastening elements are defined in a medial area defined between a radially inner edge and a radially outer edge of the body.

5. The turbine assembly according to claim 1, wherein the turbine is formed from stamped sheet metal, and the plurality of fastening elements are formed integrally with the body of the turbine.

6. The turbine assembly according to claim 1, wherein the plurality of fastening elements are configured to extend in a first axial direction away from the body such that a surface of the body of the turbine facing a second axial direction that is opposite from the first axial direction has a flat profile.

7. The turbine assembly according to claim 1, wherein the secondary component is a hub.

8. The turbine assembly according to claim 7, wherein the hub includes a plurality of hub openings each aligned with a respective one of the plurality of fastening elements.

9. The turbine assembly according to claim 1, wherein the secondary component is a drive ring.

10. The turbine assembly according to claim 9, wherein the drive ring includes a plurality of drive ring openings each aligned with a respective one of the plurality of fastening elements.

11. The turbine assembly according to claim 1, wherein the secondary component is a cover plate.

12. The turbine assembly according to claim 11, wherein the cover plate includes a plurality of cover plate openings each aligned with a respective one of the plurality of fastening elements.

13. The turbine assembly according to claim 12, wherein each of the plurality of cover plate openings are defined within a recess, such that deformation of the plurality of fastening elements causes a deformed portion of the plurality of fastening elements to be entirely housed within the recess.

14. The turbine assembly according to claim 1, wherein the turbine includes a plurality of abutment surfaces interspersed between the plurality of fastening elements, and the plurality of abutment surfaces are configured to directly contact a face of the secondary component.

15. A method of assembling torque converter components, the method comprising:
providing:
a turbine including a body defining a plurality of fastening elements integrally formed with the body; and
a secondary component including a plurality of openings configured to receive a respective one of the plurality of fastening elements;
inserting the plurality of fastening elements within the plurality of openings; and
deforming the plurality of fastening elements such that the turbine and the secondary component are connected with each other.

16. The method according to claim 15, wherein the secondary component is at least one of a hub, a drive ring, or a cover plate.

17. The method according to claim 15, further comprising applying an induction hardening treatment at least to an area of the turbine including the plurality of fastening elements.

18. The method according to claim 15, wherein the turbine includes a plurality of abutment surfaces interspersed between the plurality of fastening elements, and the plurality of abutment surfaces are configured to directly contact a face of the secondary component.

19. The method according to claim 15, wherein the plurality of fastening elements are defined along a radially inner edge of the body.

20. The method according to claim 15, wherein the secondary component is a cover plate that includes a plurality of cover plate openings each aligned with a respective one of the plurality of fastening elements, and each of the plurality of cover plate openings are defined within a recess, such that deformation of the plurality of fastening elements causes a deformed portion of the plurality of fastening elements to be entirely housed within the recess.
